(19) United States
(12) Patent Application Publication
(10) Pub. No.: US 2025/0371942 A1
(43) Pub. Date: Dec. 4, 2025

(54) ASSIGNING DIFFICULTY MODIFIERS TO SQUARES IN LINEUPS

(71) Applicant: SidePrize LLC, Atlanta, GA (US)

(72) Inventors: Grant Cloud, Atlanta, GA (US); Robert Landerman, Atlanta, GA (US); Dae Kang, Atlanta, GA (US); Andrew Barron, Atlanta, GA (US); Samuel Garvis, Atlanta, GA (US); Lambert Chu, Atlanta, GA (US); Skyler Kaufman, Atlanta, GA (US)

(21) Appl. No.: 18/731,993

(22) Filed: Jun. 3, 2024

(51) Int. Cl. G07F 17/32; G06N 7/01; G06Q 50/34

(52) U.S. Cl. CPC G07F 17/3262; G06N 7/01; G06Q 50/34; G07F 17/3288

(57) ABSTRACT

The disclosed system discussed herein may include systems, methods, and devices for dynamically adjusting contest parameters for a fantasy sports contest. A plurality of base contest parameters may be determined, where the base contest parameters are associated with one or more fantasy sports players and a predicted outcome. One or more adjusted contest parameters may be determined based on a modifier and the plurality of base parameters. A selection may be received from a participant of the fantasy sports contest. The selection may include an indication of the one or more fantasy sports players and the predicted outcome. An indication of the modifier may be received from the participant. An award may be transmitted to the participant based on the modifier, an outcome associated with the selection, and the one or more adjusted contest parameters.

### TECHNICAL FIELD

The present disclosure generally relates to systems and methods for selecting squares in a player lineup and, more specifically, assigning difficulty modifiers based on one or more of selections by a user.

### BACKGROUND

Fantasy sports, a genre of online gaming where participants assemble imaginary or virtual teams composed of proxies of real players of a professional sport, have seen an increase in popularity and engagement in recent years. These fantasy sports platforms allow users to compete against others by building teams based on the performance of the players in actual games. Existing models in fantasy sports platforms provide limited engagement strategies beyond traditional team management and scoring systems. While these platforms offer a robust framework for fantasy sports engagement, they often fail to fully exploit the potential for strategic complexity and the dynamic adjustment of payout scenarios based on how easy or difficult it is to win the specific fantasy sports contest, which could significantly enhance user experience and engagement.

Accordingly, there is an unresolved need for systems and methods for enhancing user engagement and providing dynamic gaming experiences, there remains a distinct need for innovative features that can further enrich the fantasy sports experience, specifically in terms of strategic gameplay and financial incentives.

This background information is provided to reveal information believed by the applicant to be of possible relevance. No admission is necessarily intended, nor should be construed, that any of the preceding information constitutes prior art.

### SUMMARY

Briefly described, and in various embodiments, the present disclosure generally relates to interactive gaming and digital entertainment, specifically within the context of fantasy sports. Moreover, the present disclosure is particularly relevant to systems and methods for personalizing and dynamically adjusting game parameters in response to user selections, thereby enhancing the strategic complexity and engagement of fantasy sports contests.

According to some aspects, a computing infrastructure (e.g., a computing environment, a client device, and various external resources) are provided for dynamically adjusting fantasy sports contest parameters based on one or more modifiers (e.g., demon or goblin modifiers), alongside one or more base contest parameters associated with players, statistics, and positions (e.g., more/less). According to further aspects of the disclosure, a system and method are provided for augmenting traditional fantasy sports contest mechanisms with the ability to select and modify line predictions (e.g., player performance statistics) through the use of fantasy-themed modifiers. Participants may select from an array of professional athletes, designate a statistical performance measure to track (e.g., throwing yards), and choose a position (e.g., more/less) relative to a predefined threshold. The use of demons and goblins may be incorporated to serve as strategic modifiers that participants may deploy to adjust the difficulty of their lineup to win their contest.

A demon, when selected, increases the multiplier applied to the participant's lineup, offering higher potential payouts at the expense of a more challenging performance threshold (e.g., a higher number of yards for a “more” selection). The selection of a goblin decreases the payout multiplier but offers a more attainable performance threshold (e.g., a lower number of yards for a “more” selection), catering to a different type of user strategy.

The system embodies a digital platform capable of calculating adjusted thresholds and multipliers, processing these selections, and managing one or more transactions based on the outcome of the fantasy sports contests. The method involves receiving user selections, applying the modifiers, and updating the contest parameters in real-time, thereby providing an interactive and dynamic gaming experience.

According to some aspects, a computational model may integrate a complex algorithmic framework that first establishes baseline parameters for each contest, including player performance statistics, predefined performance thresholds, and base multipliers for calculating contest payouts. A stat, a position, and a preliminary outcome may be calculated based on historical data, predictive modeling, and real-time performance metrics. These base parameters may be adjusted through the introduction of modifiers (e.g., demons and goblins) (e.g., selected by participants). For a demon modifier, the computational model recalculates the performance threshold and payout multiplier by applying an algorithmic increase, taking into account the higher difficulty of winning and higher potential prize. This adjustment is based on a set of predefined rules encoded within the model, which consider factors such as historical performance, volatility of the chosen statistic, and market trends. For a goblin trigger, the computational model applies a decrease in both the performance threshold and payout multiplier, effectively lowering the contest's difficulty but also the potential payout. This recalibration may maintain a nuanced balance, ensuring the modified parameters provide a fair and engaging challenge to the participant while maintaining the integrity and unpredictability of the contest.

Aspects of the disclosure may include a sophisticated data analytics engine that constantly updates the system with the latest player statistics, performance data, and other relevant information, ensuring accuracy and relevance of the adjustments made by demon and goblin card selections. Furthermore, the model may incorporate algorithms to manage lineups, payouts, and currency transactions, ensuring secure and efficient handling of funds based on the dynamically adjusted contest outcomes.

The disclosed computational model represents a highly advanced integration of sports analytics, risk management algorithms, and user interaction mechanisms, all designed to provide a unique, engaging, and strategically rich fantasy sports experience.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

Reference will now be made to the accompanying drawings, which are not necessarily drawn to scale.

FIG. 1 illustrates an exemplary player selection interface according to various embodiments of the present disclosure;

FIG. 2 illustrates an exemplary networked environment according to various embodiments of the present disclosure;

FIG. 3 illustrates an exemplary networked environment according to various embodiments of the present disclosure;

FIG. 4 illustrates an exemplary process for personalizing and dynamically adjusting game parameters in response to user selections according to various embodiments of the present disclosure;

FIG. 5 illustrates a schematic of an exemplary device according to various embodiments of the present disclosure; and

FIG. 6 illustrates an exemplary diagrammatic representation of a machine in the form of a computer system according to various embodiments of the present disclosure.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Prior to a detailed description of the disclosure, the following definitions are provided as an aid to understanding the subject matter and terminology of aspects of the present systems and methods, are exemplary, and not necessarily limiting of the aspects of the systems and methods, which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

User. A consumer interacting with the particular product.

Operator. An entity representing a contest (e.g., a fantasy contest) operator or organizer.

Lineup. A collection of squares submitted by a user into the operator's contest in an attempt to win the contest's prize.

Square. A single component of a lineup, based on the performance of an individual player or a combination of players.

Offer. A submission of a lineup.

Correlation. The degree to which two or more quantities are quantitatively related to one another.

Correlation Value. A measurement of correlation which may be a number between 1 and −1. A number close to 1 may mean two factors are positively correlated (e.g., they may rise or fall together and at a similar magnitude), a number close to −1 may mean the two factors are oppositely correlated (e.g., they may rise or fall oppositely and at a similar magnitude), and a number closer to 0 may mean that the two factors may be mostly random to each other, therefore not significantly correlated.

Related Contingencies. Any lineup containing squares within a correlation value that is not equal to zero (e.g., a related contingency may be any lineup that comprises square(s) that has any sort of dependent event).

Payout. An amount of value, relative to lineup and associated entry fee, which will be rewarded upon the lineup's winning the operator's contest.

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

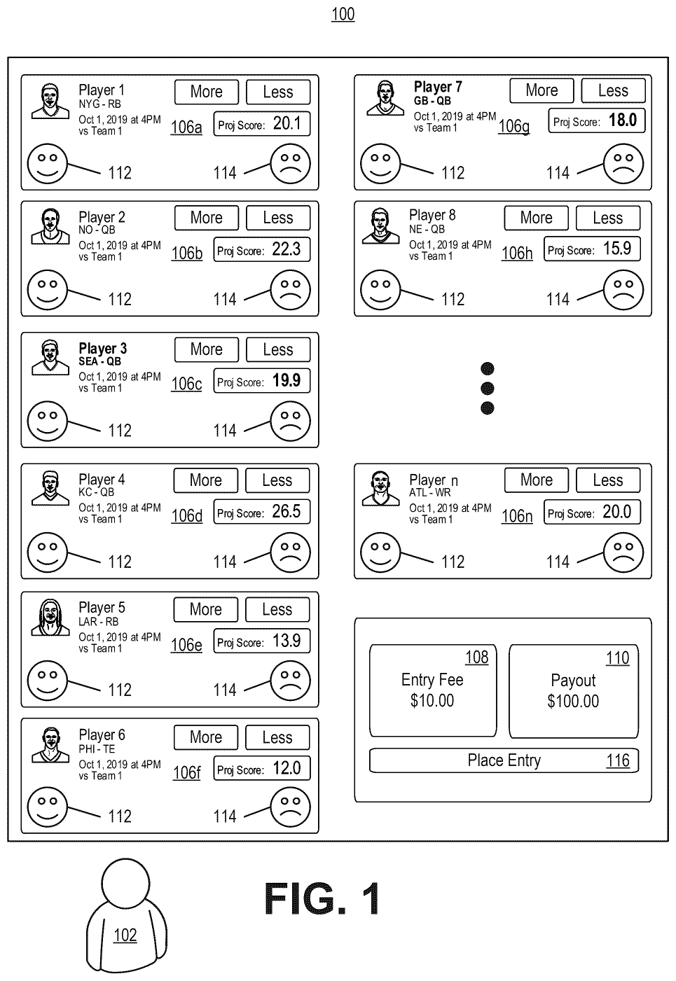

Referring now to the figures, for the purposes of example and explanation of the fundamental processes and components of the disclosed systems and processes, reference is made to FIG. 1, which illustrates an environment 100 for a fantasy sports contest including a player selection interface 104. As will be understood and appreciated, the player selection interface 104 shown in FIG. 1 represents merely one approach or aspect of the present concept, and other aspects are used according to various embodiments of the present concept.

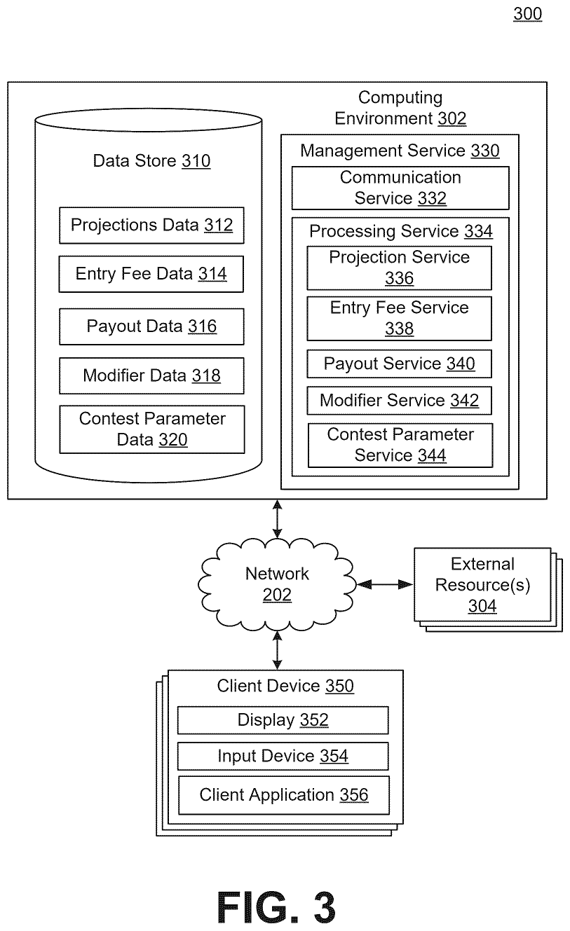

According to some aspects, the environment 100 for a fantasy sports contest may include a comprehensive platform catering to the nuanced needs of fantasy sports enthusiasts (e.g., users 102). As shown in FIG. 1, a player selection interface 104 may provide an interface for user 102 to delve into the strategic aspects of fantasy sports by selecting a number (e.g., n) of players (e.g., players 106a-106n), cumulatively referred to as players 106, for their lineups. Users 102 may interact with the player selection interface 104 through a variety of client devices (e.g., client device 350 illustrated in FIG. 3), broadening accessibility and ensuring that user 102 may engage with the player selection interface 104 from any number of devices or locations.

The player selection interface 104 may render a roster of players 106, each participating in a myriad of sporting events across different leagues and tournaments. For example, the players 106 may include one or more of athletes from major leagues such as the National Football League (NFL), Major League Baseball (MLB), National Hockey League (NHL), as well as esports competitors from League of Legends and soccer players from global competitions like La Liga and the Champions League. The diversity of players 106 may ensure that user 102 has a broad spectrum of options for creating their lineups, ranging from predicting a soccer player's performance in the Major League Soccer (MLS) league to predicting outcomes for a baseball player in the World Series. The player selection interface may allow for the inclusion of players 106 involved in events on the same day, distinct days, or multiple instances of the same player across different events, providing user 102 with flexibility in lineup creation.

The player selection interface 104 may prompt the user 102 to make predictions on outcomes based on associated events, introducing a strategic layer to the selection process. Outcomes may be presented as selectable results, such as predicting whether a football quarterback will throw more or less than three touchdowns in an upcoming game. This system of outcome selection may be further enriched with options for occurrence and non-occurrence selections, alongside a ‘hit’ selection for precise predictions. Such detailed prognostication opportunities may empower user 102 to engage deeply with the sports they love, challenging their analytical skills and understanding of each sport's nuances.

Lineup selection within the player selection interface 104 may introduce another strategic dimension, where user 102 may define the size of their lineup, choosing from a range of squares that may include two or more players and their associated events. User 102 may weigh the likelihood of correctly predicting outcomes across a larger set of selections against the potential for higher rewards. This balance between the likelihood of winning and the variance in the payout multiplier may enhance the appeal of the fantasy sports contest, offering a compelling challenge. Upon selecting their lineup, user 102 may be prompted to choose an entry fee 108, with the interface displaying the potential payout 110 associated with their selections and the chosen entry fee 108.

The player selection interface 104 may incorporate one or more increased difficulty modifiers 112 (e.g., “Demons”) and/or decreased difficulty modifiers 114 (e.g., “Goblins”). Selection of the one or more increased difficulty modifiers 112 (e.g., “Demons”) and/or decreased difficulty modifiers 114 (e.g., “Goblins”) may dynamically adjust the potential payout 110 based on the user's selections. The one or more increased difficulty modifiers (e.g., “Demons”) and/or decreased difficulty modifiers (e.g., “Goblins”) may introduce an additional layer of strategic depth, allowing user 102 to tailor their gaming experience according to their strategic preferences. Upon selecting their lineup of players 106 and one or more increased difficulty modifiers (e.g., “Demons”) and/or decreased difficulty modifiers (e.g., “Goblins”), user 102 may be provided with immediate feedback on the potential payout (110), which may be influenced by the applied difficulty modifiers.

For example, user 102 may feel confident about their predictions of one or more players 106 and might select one or more increased difficulty modifiers 112 (e.g., “Demons”) to seek an additional challenge, capitalizing on the higher difficulty of winning and potentially secure a larger payout. Alternatively, if user 102 is a more cautious player they may prefer one or more decreased difficulty modifiers 114 (e.g., “Goblins”) to minimize the difficulty of their lineup winning the contest, accepting smaller rewards in exchange for a perceived higher likelihood of winning the contest.

Upon making their selections, user 102 may receive feedback on how these choices affect the entry fee 108 and potential payout 110. This feedback may ensure that user 102 may make informed decisions, understanding the implications of their difficulty modifiers on the game's financial aspects. Not only is the user's engagement enhanced by allowing for a customized difficulty and payout balance, but strategic elements of the game are also deepened, making the fantasy sports contest platform more appealing and engaging.

The inclusion of a submission selection 116 may allow user 102 to finalize and submit their entry into the contest, marking the culmination of their strategic deliberations. By providing user 102 with detailed information regarding their selected projections, the player selection interface 104 may ensure that user 102 is fully informed of the potential rewards for their lineup, fostering an environment of transparency and strategic engagement.

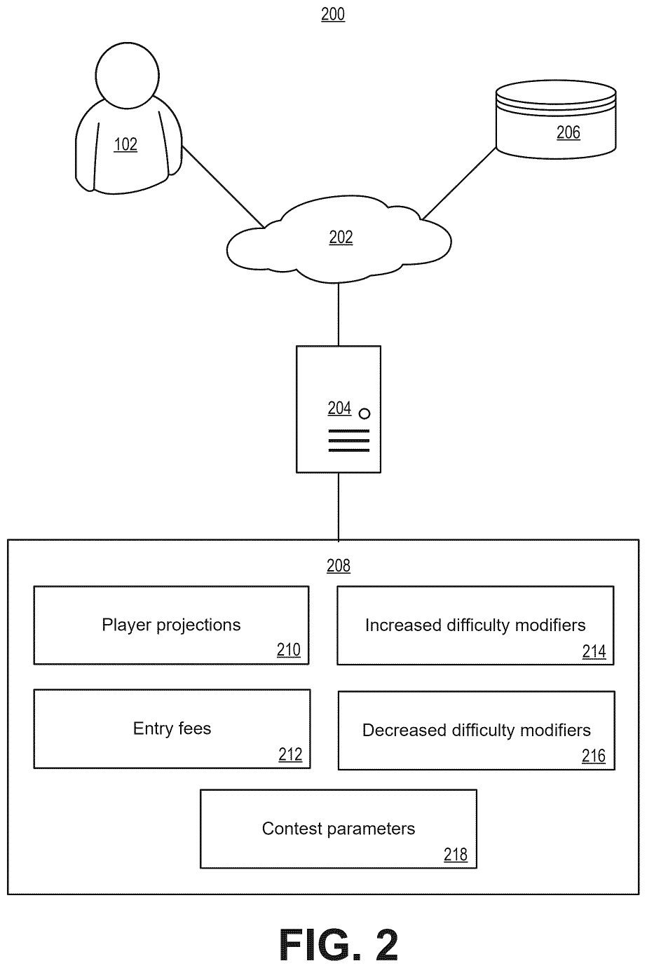

As shown in FIG. 2, an environment 200 for a fantasy sports contest may facilitate interactive fantasy gaming for a user 102. The environment 200 may include a network 202, a server 204, and a database 206. The individual elements of the environment 200, working in concert, may deliver a seamless and engaging fantasy sports experience, leveraging advanced algorithms and data analytics to apply one or more increased difficulty modifiers 112 (e.g., “Demons”) and/or decreased difficulty modifiers 114 (e.g., “Goblins”) for adjustments to payout modifiers, impacting gameplay by tailoring the experience to individual user preferences and difficulty appetites.

The network 202 may provide a versatile and dynamic conduit that enables communication and data exchange across the environment 200. The network 202 may encompass a wide range of connection types, including wired, wireless, and cloud-based technologies, ensuring that user 102 may access the fantasy sports contest platform from virtually anywhere. This connectivity may support real-time interactions and updates, allowing user 102 to make informed decisions based on the latest available information, ranging from player performance data to changes in contest dynamics.

According to some aspects, the server 204 may act as a central processing unit within the environment 200, orchestrating the myriad operations necessary to run the fantasy contests efficiently. The server 204 may handle tasks ranging from user authentication and data processing to the execution of complex algorithms utilized by a difficulty modifier module 208. Moreover, the server 204 may manage flow of information between user 102 and the system, ensuring that user selections, lineups, and other inputs are accurately recorded and reflected in the contest outcomes.

The database 206 may store a vast array of information associated with the operation of the fantasy sports contests. For example, the database 206 may include one or more of user profiles, player statistics, contest results, contest parameters, and other data points. By maintaining a comprehensive and up-to-date repository of information, the database 206 may enable the server 204 to perform detailed analyses and make informed decisions regarding application of one or more increased difficulty modifiers 112 (e.g., “Demons”) and/or decreased difficulty modifiers 114 (e.g., “Goblins”) to determine one or more contest parameters, e.g., setting a baseline for expected outcomes based on the user's selections.

The database 206 may archive numerous forms of data, including one or more of user interaction and preferences, player and game statistics, financial models and structures, difficulty modifier impact analysis, predictive modeling data, difficulty modifier definitions and parameters, and/or dynamic adjustment records. The information stored by the database 206 may ensure the server 204 may dynamically and intelligently adjust game parameters in real-time, tailoring the gaming experience to individual user strategies and preferences.

User interaction and preferences data may include, but is not limited to, the frequency and contexts in which users select difficulty modifiers, reflecting their behaviors and strategic inclinations within different sports and contests. The user interaction and preferences data may also capture any explicit user preferences for difficulty levels, e.g., whether they lean towards higher difficulty, higher prize scenarios by favoring Demons, or prefer a conservative approach with Goblins. Additionally, the user interaction and preferences data may track the outcomes of these selections, such as wins and losses, and the financial impacts, providing a historical dataset. For example, a user's history may show a pattern of selecting Demons for high-stakes NFL games but opting for Goblins in more unpredictable esports contests. This comprehensive collection of user interaction and preferences may be used to offer personalized experiences, tailor recommendations, and adjust game dynamics in alignment with individual user strategies.

Player and game statistics data may include a wide range of metrics, including individual player performances across various sports, historical game outcomes, seasonal averages, injury reports, and other relevant statistical insights that may influence game predictions and strategies. For instance, the database 206 may include detailed statistics such as a basketball player's points per game, assists, rebounds, shooting percentages, and defensive records, alongside team performance metrics like win-loss records, standings, and recent form. These statistics may be continuously updated to reflect the most current data, ensuring that when difficulty modifiers are applied, they are based on the most accurate and relevant information. This data may be used by one or more algorithms, which calculate different sets of projections, and personalize the gaming experience by allowing users to make informed decisions when selecting their lineup and applying difficulty modifiers to potentially enhance their prize payouts or make it easier to win, but at the consequence of a lower prize payout.

Financial models and structures data may include detailed records of base entry fees, standard payout ratios, and the mathematical formulas used to adjust these figures in response to the selection of increased difficulty modifiers (“Demons”) and decreased difficulty modifiers (“Goblins”). Such financial data may be used to dynamically calibrate the economic aspects of the game to align with user strategies and preferences, ensuring a balanced and fair play environment. For example, the database 206 may contain information showing that the application of a Demon to a user's lineup results in a proportional increase in the potential payout, reflecting the added difficulty of winning. The selection of a Goblin could adjust the payout to a smaller multiplier, catering to users seeking an easier win in a contest, at the cost of a smaller prize payout. This financial data may enable an offering of varied gaming experiences, with a wide range in difficulty levels, accommodating a wide spectrum of user preferences and lineup strategies.

Difficulty modifier analysis data may include a wide array of analytics, such as the frequency of difficulty modifier selections by users, the outcomes of contests where modifiers were used (e.g., win-loss ratios), and the financial impact (e.g., changes in entry fees and payouts). Additionally, difficulty modifier analysis data may analyze user behavior patterns, such as tendencies to select certain types of difficulty modifiers under specific conditions or in particular sports, and the subsequent success rates of these strategies. For instance, the database may track and analyze scenarios where the application of a Demon significantly increased the payout for a higher difficulty lineup that won a contest, or cases where the use of a Goblin stabilized a user's performance by providing lineups that were less difficult to win. This comprehensive dataset may not only provide insights into the overall effectiveness and appeal of difficulty modifiers but also aid in refining the algorithms to enhance user engagement, satisfaction, and financial outcomes, ensuring a balanced and engaging gaming experience.

Predictive modeling data may include historical game outcomes, player performance statistics, team dynamics, seasonal trends, and user lineup patterns, each of which may be fed into sophisticated machine learning algorithms. The algorithms may analyze patterns and predict future game outcomes, player performances, and the potential impact of specific difficulty modifiers on those predictions. For example, predictive models may evaluate a football player's likelihood of scoring a certain number of touchdowns based on past performance, current fitness levels, and opposition strength. When a user opts to apply a “Demon,” the model may adjust its predictions, taking into account the increased difficulty and recalculating the potential rewards. This predictive modeling data may ensure that difficulty modifiers are applied in a contextually relevant manner, enhancing the strategic depth of the game while maintaining fairness and competitiveness. By continuously updating and refining these models with new data, dynamic, engaging, and personalized gaming experiences may be tailored to the evolving landscape of fantasy sports.

Difficulty modifier definitions and parameters may include detailed descriptions of each difficulty modifier's function, the conditions under which they can be applied, and the mathematical rules that govern how they alter game parameters such as entry fees, payout ratios, and projection modifiers. For instance, a “Demon” may be defined to increase the potential payout by a certain percentage but also raise the difficulty level of the prediction criteria, while a “Goblin” may be set to decrease the difficulty level by simplifying the prediction criteria but at the cost of a reduced payout. These definitions and parameters may ensure that the application of difficulty modifiers is systematic, predictable, and in line with the platform's strategic gaming framework. By storing the difficulty modifier definitions and parameters information, database 206 may enable the platform to dynamically adjust the gaming experience in real-time, providing users with a rich array of strategic options tailored to their preferences and enhancing the overall engagement and competitiveness of the fantasy sports contests.

Dynamic adjustment records data may include changes made to game parameters based on increased difficulty modifiers (“Demons”) and decreased difficulty modifiers (“Goblins”). Every adjustment may be logged, including the specific difficulty modifier applied, the pre- and post-adjustment parameters (e.g., entry fees, potential payouts, and projection modifiers), and the context of the adjustment (e.g., user selections, game conditions). For example, dynamic adjustment records may include an instance where a user applies a “Demon” to their lineup, prompting an increase in the potential payout due to the added difficulty. These records may not only serve as a tool for auditing and analyzing the impact of difficulty modifiers on the platform's economy and user engagement but also fuel the predictive models and strategic recommendations by providing historical data on user behavior, game outcomes, and financial dynamics. Accordingly, the dynamic adjustment records may enable the platform to offer a continuously optimized, user-centric gaming experience that adapts to changing strategies and preferences.

An assortment of other data points housed within database 206 may include market trends, sports event schedules, real-time sports news, and injury reports, amongst others. This data may be instrumental for the adaptive algorithms employed by server 204. Real-time sports news and injury reports, for example, may have immediate impacts on player statistics and contest outcomes, necessitating swift adjustments to difficulty modifiers and contest parameters to maintain an equitable contest environment. Market trends, on the other hand, may provide insights into user behavior and preferences, influencing the strategic deployment of difficulty modifiers to enhance user engagement and platform loyalty.

A difficulty modifier module 208 may be a software component and/or a specialized component, operating with the server 204 or within the server 204. The difficulty modifier module 208 may receive data from the database 206, including user interactions and preferences, player and game statistics, financial models and structures, difficulty modifier impact analysis, predictive modeling data, difficulty modifier definitions and parameters, and dynamic adjustment records, to dynamically assign line modifiers through the application of increased difficulty modifiers (“Demons”) and/or decreased difficulty modifiers (“Goblins”). For instance, the difficulty modifier module 208 may receive player and game statistics for an upcoming NFL game from the database 206 and evaluate, based on the player and game statistics, the current performance metrics of the chosen players. Simultaneously, the difficulty modifier module 208 may reference financial models to understand the base entry fee and payout structure for the game, adjusting these according to the difficulty profile introduced by a “Demon.” The “Demon” may be presented to a user, known for their affinity for high-difficulty strategies based on their interaction and preferences data.

The difficulty modifier's impact may be further refined by predictive modeling data, which may be used to forecast the players' performances based on historical trends, current conditions, and similar past selections by the user or others with a similar profile. The definition and parameters of the “Demon” may provide a framework for quantifying the increase in difficulty and potential reward, which may be logged in the dynamic adjustment records for future analysis. For example, the algorithm may adjust the payout multipliers if the predictive model suggests a high-scoring game for a “Demon” that doubles the payout for a square achieving “more” on the relevant stat category to reflect this updated scenario.

Difficulty modifier impact analysis data may be analyzed to determine insights into the historical success and financial implications of similar strategies, helping the difficulty modifier module 208 to calibrate the adjustments in a manner that balances user engagement with platform sustainability. Through this sophisticated interplay of data and algorithms, the difficulty modifier module 208 may assign line modifiers that reflect both the individual's strategic preferences and the broader dynamics of the fantasy sports contest, thereby enhancing the personalized gaming experience and strategic depth of the platform.

Player projections 210 may serve as an input for adjusting contest parameters 218. The player projections 210 may include forecasts of how individual athletes are expected to perform in upcoming games or events, based on a variety of factors such as historical performance, current season statistics, player health, and opposition strength. One or more users may select the player projections 210 to inform their contest strategies, based on the anticipated performance of players in real-world sporting events.

According to some aspects, the difficulty modifier module 208 may incorporate a collective predictive wisdom of a plurality of users. For instance, when a large number of users select similar outcomes for a specific player's performance (e.g., indicating a consensus expectation) the difficulty modifier module 208 may adjust the projections or payout ratios associated with those outcomes, reflecting the aggregated confidence in those projections.

One or more algorithms may analyze a volume or nature of user selections on player projections 210. One such algorithm may employ a Bayesian updating mechanism, which may adjust the probability of outcomes based on the user selections. For example, if an unexpected number of users project a breakout game for an under-the-radar running back, the algorithm could interpret this as a signal to adjust the projections in favor of that player exceeding their usual performance metrics, e.g., by increasing the projection and decreasing the payout multiplier for lineups with align with this projection.

Another algorithmic approach may include a use of collaborative filtering to detect patterns in user selections of player projections 210. The collaborative filtering may consider direct selections of player outcomes and may infer correlations between different players and outcomes based on user behavior. For instance, if collaborative filtering reveals that users who project high performance for a particular quarterback also tend to project high receptions for a specific wide receiver, the difficulty modifier module 208 may adjust the contest parameters to reflect the implied confidence in this receiver's performance, even if not directly selected by a large number of users.

Moreover, the difficulty modifier module 208 may implement a crowd wisdom aggregation model, which may quantitatively assess the collective accuracy of the user base over time. By tracking the historical accuracy of the player projections 210, the algorithm may assign weights to current projections based on past performance. For example, if the collective wisdom has historically been highly accurate in projecting performances in specific types of games (e.g., playoff games or matches against rival teams), the module may more significantly adjust the projections or contest parameters in response to player projections 210 for such games. For example, in a scenario where a significant majority of users select a projection indicating that a well-known soccer player will score multiple goals in an upcoming match, the difficulty modifier module 208, recognizing the cumulative wisdom and confidence of the user base, may respond by decreasing the payout for lineups including squares based on that player scoring, as the consensus projection reduces the perceived difficulty. The module may increase the payout for opposing outcomes to maintain balance and incentivize participants to choose lineups with a higher degree of difficulty of winning.

The difficulty modifier module 208 may consider the amount of entry fee 212, as selected by one or more users 102, in conjunction with their selection of player projections 210, to dynamically adjust contest parameters 218. This approach may allow the difficulty modifier module 208 to calibrate the contest dynamics based on the entry fee users are willing to commit, thus aligning the difficulty and payout aspects of the contest more closely with user preferences.

One algorithm that may be used by the difficulty modifier module 208 may include a risk assessment model that evaluates the aggregate amount of entry fees associated with specific player projections. If the model detects that a disproportionately high volume of entry fees is placed including squares that are based on a particular outcome (e.g., indicating a strong user confidence in that outcome) the difficulty modifier module may adjust the projections or payout ratios for that outcome to maintain the contest's balance. For example, if users collectively place a high amount of entry fees on a quarterback exceeding a certain yardage threshold, the module may decrease the payout associated with that outcome to mitigate the platform's exposure and encourage entry fees on lineups that include squares based on alternative outcomes.

According to some aspects, the difficulty modifier module 208 may implement an elasticity-based algorithm, which dynamically may adjust payout ratios or projections based on the elasticity of user entry fees relative to entry fee levels. The algorithm may calculate the sensitivity of user behavior to changes in potential payouts or projections, allowing the module to optimize the contest parameters for maximum engagement. If the algorithm identifies that lower entry fees are associated with users seeking higher difficulty lineups, it may adjust the contest parameters to offer higher rewards for more difficult to win lineups, thereby incentivizing a wider range of strategic behaviors across different entry fee levels.

Furthermore, the difficulty modifier module 208 may implement a machine learning model that predicts the expected distribution of entry fees across various outcomes and uses these predictions to dynamically adjust contest parameters. The machine learning model may take into account historical data on user lineup patterns, including the relationship between entry fee amounts and selected player projections, to forecast the allocation of entry fees in upcoming contests. Based on these forecasts, the difficulty modifier module 208 may preemptively adjust projections or payout ratios to ensure an equitable distribution of winning lineups. For instance, if the machine learning model predicts a significant clustering of entry fees on a few highly favored outcomes, the module may proactively adjust the projections to encourage more diverse lineups to be entered into contests, enhancing the contest's competitiveness and fairness.

In practice, if the difficulty modifier module 208 observes an inordinate concentration of entry fees 212 on the outcome of a player achieving a specific milestone (e.g., a basketball player scoring over 30 points in a game), it might respond by adjusting the contest parameters to either lower the payout for that outcome or enhance the attractiveness of alternative outcomes. This not only ensures that the contest remains financially viable for the platform but also maintains an engaging and strategically diverse environment for all participants.

The difficulty modifier module 208 may employ the increased difficulty modifier 214 and the decreased difficulty modifier 216 (e.g., in conjunction with player projections 210 and/or entry fees 212) to dynamically adjust contest parameters 218. When a user selects an increased difficulty modifier 214, they signal a willingness to embrace higher difficulty for potentially greater payouts. Selecting a decreased difficulty modifier 216 indicates a preference for a more conservative approach, accepting lower prize payouts for reduced difficulty. The difficulty modifier module 208 may interpret these selections to adjust the contest parameters accordingly, affecting projections, payout ratios, and performance thresholds.

The difficulty modifier module 208 may implement a weighted projections adjustment model. The weighted projections adjustment model may increase the payout ratios for outcomes associated with higher difficulty modifiers, e.g., reflecting the elevated difficulty level users are willing to accept. For example, an increased difficulty modifier may be applied to a player projection (e.g., by a user expecting a relatively unlikely outcome, such as a soccer player scoring more than three goals in a match). The payout multiplier of the outcome may be boosted, increasing the potential payout to match the increased difficulty of such square having a winning outcome.

According to some aspects, the difficulty modifier module 208 may implement a probabilistic threshold adjustment algorithm. The probabilistic threshold adjustment algorithm may adjust the performance thresholds for winning a contest in a manner that reflects the decreased difficulty appetite. For example, the difficulty modifier module 208 may lower the points threshold needed to win the contest for a decreased difficulty modifier 216 for a basketball player's points in a game, but also adjust the payout ratio downwards, as the contest is now easier to win.

Additionally, the difficulty modifier module 208 may employ a machine learning-based evaluation model that dynamically calibrates the contest parameters based on the collective impact of difficulty modifiers (e.g., increased difficulty modifier 214 or decreased difficulty modifier 216) selected by the user base. The machine learning model may analyze historical and real-time data on how different difficulty modifiers have influenced contest outcomes and user engagement, adjusting the parameters to optimize the balance between difficulty to win and payout multipliers. For example, if the machine learning model detects that increased difficulty modifiers 214 tend to result in higher user engagement and satisfaction when associated with specific types of player projections 210, it may automatically adjust the projections and payouts for similar future contests to encourage the selection of these modifiers. In practice, should a significant number of users 102 apply increased difficulty modifiers 214 to the outcome of a player achieving a specific performance milestone, the difficulty modifier module 208 may respond by slightly adjusting the projection s to ensure the platform remains financially balanced while still offering attractive payouts. This adjustment is nuanced to prevent disproportionately skewing the contest's economics while maintaining its attractiveness and competitiveness.

According to some aspects, a feedback loop algorithm may be implemented by the difficulty modifier module 208, where the system may learn from the outcomes of past adjustments to continuously refine and optimize future contest parameters. The feedback loop algorithm may account for user response to previous adjustments (e.g., changes in contest volume or patterns) and uses the user response data to make more informed adjustments moving forward. For example, if the system notices that past increases in payout ratios for high-difficulty lineups led to higher user engagement without compromising platform profitability, it may apply similar adjustments in future contests.

As shown in FIG. 3, the networked environment 300 may facilitate fantasy sports contests, leveraging advanced algorithms and data analytics to apply one or more increased difficulty modifiers 112 (e.g., “Demons”) and/or decreased difficulty modifiers 114 (e.g., “Goblins”) to dynamically adjust contest parameters 218. This networked environment 300 may include a computing environment 302, various external resources 304, and client device 350, one or more of which may be interlinked via a network 202. One or more of the client devices 350 may include a display 352, input device 354, and/or a client application 356. Network 202, including one or more of the Internet, LANs, WANs, and wireless connections, may provide communication within the networked environment 300, including real-time data exchanges, updates, and interactions.

The computing environment 302 may operate within a single device or may span across multiple devices or servers. These devices, potentially distributed across different locations, may work collectively to process, administer, and manage the functionalities associated with the fantasy contests. Moreover, the computing environment 302 may adapt to the computational demands, making it an elastic resource capable of scaling according to the operational needs of the fantasy sports platform. It handles crucial tasks such as lineup processing, outcome determinations, payouts distributions, and analytical data management, positioning it as the central node of the networked environment.

The data store 310 may serve as a repository for an array of data types associated with the fantasy contest's operation, including projections data 312, entry fee data 314, payout data 316, modifier data 318, contest parameter data 320, and various other datasets that may contribute to the fantasy gaming experience. Each dataset may be used to facilitate the dynamic adjustment of entry fees and potential payouts based on the user's selections, including the application of difficulty modifiers. The projections data, for example, may encompass detailed information about athletes that users can leverage to make informed decisions when forming their fantasy lineups. This includes performance statistics, team affiliations, and event-specific data that are essential for the analytical algorithms to evaluate and apply the appropriate projections for the operator to set for contests.

Projections data 312 may include detailed information about the athletes around which the fantasy sports contests revolve. Projections data 312 may include performance statistics, team affiliations, and event-specific data that user 102 may leverage to make informed decisions when forming their fantasy lineups. By pulling in this data from external resources 304, the computing environment 302 may ensure that user 102 has access to current and comprehensive player information.

According to some aspects, projections data 312 may include identification and contextual information about athletes, including but not limited to, the player's name, the team they represent, the sport they participate in, and their specific role or position within the team. This athlete information may be associated with allowing user 102 to recognize and select players based on team compositions, individual preferences, or strategic considerations aimed at optimizing their fantasy team's performance. Projections data 312 may further integrate a broad spectrum of performance statistics for each athlete. These statistics may provide quantitative measures of a player's contributions to their team's efforts, including scoring, assists, defensive achievements, and other relevant performance metrics. Detailed statistical information may enhance the fantasy sports experience by influencing the points accrued by users' fantasy teams based on real-world athlete performances.

To further enrich the decision-making process, projections data 312 may include additional contextual variables that may influence an athlete's performance. These contextual variables may include data on a player's teammates, the leagues and competitions they are involved in, and upcoming sporting events they are scheduled to participate in. This additional layer of information may offer user 102 insights into the dynamics of team synergy, the competitive landscape of various leagues, and the strategic importance of specific events, all of which may inform more nuanced player selection strategies. Moreover, projections data 312 may account for environmental factors such as the geographical location of sporting events and prevailing weather conditions, recognizing their potential impact on game outcomes and individual performances. For example, athletes may exhibit varying performance levels under different weather conditions or at specific venues, influencing the strategic selection of players for fantasy teams.

Historical performance data and analytics included in projections data 312 may afford user 102 a deeper exploration into an athlete's performance trends and potential. Historical data may highlight patterns and consistency in performances over time, while analytics may offer predictive insights, equipping the user 102 with advanced tools to gauge future performance probabilities. Projection data 312 may be dynamically maintained, with continuous updates from a variety of external resources 304, such as sports statistics databases, event data feeds, and other gaming platforms, ensuring that the platform delivers the most current and comprehensive player information possible, enabling users to base their fantasy team selections on the latest available data.

Projection data 312 and entry fee data 314 further refine the contest dynamics by encapsulating the predictive aspects of the contests and the financial commitments made by users. These data points influence the formation of lineups and the structuring of contest payouts, making them fundamental to the strategic depth of the fantasy contests. Projections data 312 may encompass selections made by user 102 concerning player performances within the framework of fantasy sports contests. This dataset may include a collection of users' predictions on various aspects of athletes' performances in upcoming games, including, but not limited to, points scored, yards gained, goals made, assists, rebounds, and other sport-specific performance metrics. These projections reflect the users' expectations and strategic choices, based on their analysis or intuition about future sports events.

The projections data 312 may be associated with calculated potential outcomes, and determine payouts based on the accuracy of these user-generated projections. Each entry in the projections data 312 may be linked to increased difficulty modifiers (e.g., “Demons”) and decreased difficulty modifiers (e.g., “Goblins”), serving as an input for algorithms that assess associated modifications to difficulty and payouts, contributing to the overall gaming strategy. By aggregating and analyzing these user selections, the system may offer insights into popular trends, potential sleeper picks, and widely anticipated outcomes, enriching the community's collective intelligence.

Projections data 312 may be continuously updated with new user selections and may be maintained to ensure data integrity and relevance. Initial projections may be captured, as well as accommodating changes users might make up to a cut-off time before the actual sporting events, reflecting late-breaking news or last-minute strategic adjustments. As such, projections data 312 may evolve with the sports calendar and the participatory dynamics of the fantasy sports contests, serving as a component of the platform's engagement mechanics and its appeal to users seeking a deeply interactive and competitive fantasy sports experience.

Entry fee data 314 may include data associated with the selection of entry fees by user 102 for participation in fantasy sports contests. The entry fee data 314 may represent the financial engagement of user 102 with the platform, recording the entry fees the user 102 is willing to commit to compete in various fantasy contests. Entry fee data 314 not only captures the amount selected by each participant but also provides data for the economic model of the fantasy sports platform. By aggregating these financial commitments, the system may balance increased difficulty modifiers (e.g., “Demons”) and decreased difficulty modifiers (e.g., “Goblins”) with associated entry fees and payouts, tailoring contests to meet diverse user preferences.

Moreover, entry fee data 314 may serve an input for several operational and analytical processes within the system. The entry fee date may be used in the calculation of contest payouts, ensuring that winnings are distributed based on predefined criteria reflective of the contest's prize pool and participant performance. Furthermore, entry fee data 314 may reflect increased difficulty modifiers (e.g., “Demons”) and decreased difficulty modifiers (e.g., “Goblins”).

Payout data 316 may be determined based on increased difficulty modifiers (e.g., “Demons”) and decreased difficulty modifiers (e.g., “Goblins”). Payout data 316 may include information regarding the potential financial rewards that users stand to gain based on their contest entries, including the selection of players and the application of difficulty modifiers to these selections. This data may be dynamically adjusted and calculated based on a complex interplay between user-selected difficulty modifiers, the entry fees committed by users, and the performance projections for the athletes involved. The application of difficulty modifiers may influence the potential payouts, with “Demons” generally increasing the difficulty and, consequently, the potential payouts, while “Goblins” decrease the difficulty along with the potential payouts.

The storage of payout data 316 may be structured to accommodate the variability introduced by the difficulty modifiers, ensuring that the system can accurately reflect changes in potential payouts in real-time. This involves continuously updating the payout structures to mirror the current lineup landscape, user strategies, and the latest performance data. The data store 310 may be used to recalculate potential payouts for users to apply these modifiers to their selections, taking into account not only the base probabilities of the selected outcomes but also the modified difficulty profiles associated with the user's choice of modifiers. This ensures that the payout data remains relevant, precise, and reflective of the current gaming conditions, providing users with up-to-date information on their potential winnings.

Furthermore, the data store 310's handling of payout data 316 enables the fantasy sports platform to maintain transparency and fairness in contest operations. By systematically adjusting payouts based on well-defined algorithms that account for the impact of difficulty modifiers, the platform ensures that users are rewarded in proportion to the difficulty level they choose. This approach not only enhances the gaming experience by adding layers of strategic depth and financial decision-making but also fosters a competitive environment where skill and insight are duly rewarded. The meticulous management and storage of payout data, therefore, are instrumental in aligning the platform's economic model with the dynamic and strategic nature of fantasy sports contests.

Modifier data 318, stored within the data store 310 of the networked environment 300, may allow dynamic adjustment of the difficulty levels associated with contest entries. The modifier data 318 may include detailed information on increased difficulty modifiers (“Demons”) and decreased difficulty modifiers (“Goblins”), along with the rules and parameters that govern how these modifiers affect the entry fee and potential payout. The inclusion of difficulty modifiers may introduce a strategic element to the contests, enabling users to tailor their gaming experience according to their strategic outlook. The storage of modifier data 318 may be comprehensive, capturing not only the classification and effect of each modifier but also the contextual rules and probabilities that dictate the application of these modifiers to the users' selections.

The architecture of the data store 310 may facilitate the organization and retrieval of modifier data 318, ensuring that the application of difficulty modifiers to user entries is both accurate and reflective of the current contest dynamics. The modifier data 318 may include algorithms and formulas used to calculate adjusted probabilities of outcomes based on the application of difficulty modifiers, thereby influencing the recalculated potential payouts. The impact of each difficulty modifier may be immediately reflected in the contest setup. As such, the data store 310 may accommodate rapid updates and modifications to the modifier data, allowing for the introduction of new modifiers or the adjustment of existing ones based on gameplay analytics and user feedback.

The data store 310 may include contest parameter data 320, e.g., for the dynamic adjustment of contest dynamics based on user interactions, difficulty preferences, and strategic decisions. The contest parameter data 320 data may encompass a wide array of information, including but not limited to, detailed algorithms for difficulty assessment, parameters for adjusting contest dynamics, and other elements that may contribute to the real-time recalibration of contests in response to user inputs such as player projections, entry fees, and difficulty modifiers.

For example, contest parameter data 320 may include algorithms that specifically address the recalibration of projections or payout ratios for the cumulative application of increased difficulty modifiers (“Demons”) or decreased difficulty modifiers (“Goblins”). One such algorithm may be a dynamic projections adjustment algorithm, which may recalculate the difficulty of achievement of specific outcomes based on the overall balance of lineups and/or certain squares placed across different contest outcomes, incorporating the profile alterations associated with application of difficulty modifiers. Moreover, if a significant volume of users opts for increased difficulty modifiers on a high-payout outcome, the algorithm may adjust the projections to reflect the increased exposure assumed by the platform, thus ensuring a balanced distribution.

Another component of the contest parameter data 320 may include adjustment parameters that dictate how user-selected entry fees influence contest dynamics. For example, a scaling algorithm may adjust payout ratios based on an aggregate amount of entry fees committed to particular outcomes, ensuring that payouts remain proportionate to the level of financial engagement by the users. Additionally, the contest parameter data 320 may include one or more parameters for adjusting the performance thresholds in sports contests, directly influenced by the aggregate application of difficulty modifiers. An example may include a threshold adjustment algorithm that modifies performance benchmarks, such as points scored by a player in a game, based on the distribution of difficulty modifiers across all projections. If the majority of projections or entries on a player scoring above a certain point threshold come with increased difficulty modifiers, the algorithm may raise the performance threshold to maintain contest balance and fairness.

Moreover, the contest parameter data 320 may include machine learning models that learn from past contest outcomes and user lineup patterns to predict and automatically adjust contest parameters in a way that enhances user engagement and platform profitability. For instance, a predictive analytics model may use historical data to identify patterns in user behavior when faced with specific contest setups and adjust the difficulty modifiers, entry fee thresholds, or payout structures accordingly to optimize future contest engagement.

The management service 330, situated within the computing environment 302, may perform one or more functions to provide a seamless, engaging, and fair fantasy sports experience. The management service 330 may oversee the reception and processing of user submissions, including lineup selections and entry fees, ensure the accurate calculation and distribution of contest outcomes and payouts, and determine contest parameters. Moreover, the management service 330 may aggregate and analyze vast data sets related to contest dynamics, user behavior, and performance metrics, facilitating the system's decision-making processes and strategic direction. Furthermore, the management service 330 may be adaptive and scalable, capable of adjusting to fluctuations in user demand and contest complexity. This flexibility may allow the computing environment 302 to support an expanding array of fantasy sports contests, adapt to changes in sporting schedules, and incorporate new features or functionalities as the platform evolves.

The management service 330 may include one or more sub-services such as the communication service 332 and the processing service 334, each responsible for specific operational aspects. The communication service may ensure efficient data distribution and interaction within the networked environment, while the processing service 334 may handle the analytical and computational tasks necessary for the contest's execution. The communication service 332 may manage data exchanges between users' client devices, external resources, and internal computational processes. Moreover, the communication service 332 may ensure the timely and secure transmission of information, facilitating real-time interactions and access to up-to-date contest data, such as user registration details, player selections, and the outcomes of sporting events that influence contest results.

The processing service 334 within the computing environment 302 may execute a broad spectrum of analytical and computational duties associated with the operation and enhancement of the platform. The processing service may include one or more specialized sub-services, including the projection service 336, entry fee service 338, payout service 340, modifier service 342, and contest parameters service 344, each providing a specific aspect of the fantasy sports contest ecosystem. Cumulatively, these services may perform functions such as outcome prediction, selection assessment, modifier assessment, entry fee determination, payout determination, contest parameter determination, and the generation of insightful analytics. Through its comprehensive data processing capabilities, the processing service 334 may enable the platform to offer personalized contest experiences, apply modifiers, and continuously enhance the platform based on user feedback and performance analytics.

The projection service 336 may perform analysis and valuation of projections made by user 102. Utilizing projections data 312, projection service 336 may evaluate the selections made by user 102, which may include a range of attributes such as player performance, game outcomes, and statistical milestones. The projection service 336 may aggregate the user selections and assesses the choices across various dimensions, including player form, team dynamics, and historical data, to determine a value for the projections by user 102. This value may reflect the expected performance level. Further, the projection service 336 may provide user 102 with insights into the potential outcomes of their fantasy selections. By assigning a projections value, the projection service 336 may allow user 102 to gauge the strength and potential success of their lineup choices relative to the real-world performances of athletes and teams.

The entry fee service 338 may determine the appropriate entry fee for participants in fantasy sports contests. This determination process may incorporate application of difficulty modifiers, including both increased difficulty modifiers (“Demons”) and decreased difficulty modifiers (“Goblins”), to accurately reflect the added reduced difficulty associated with a user's contest lineup. The entry fee service 338 may utilize a sophisticated algorithm that analyzes the selected difficulty modifiers' impact on the potential outcomes of the contest entries.

The payout service 340 may determine the appropriate payouts for fantasy sports contests, including the application of difficulty modifiers, such as increased difficulty modifiers (“Demons”) and decreased difficulty modifiers (“Goblins”). This payout service 340 may employ a detailed algorithm that takes into account not only the outcomes of user-selected projections but also the impact of any applied difficulty modifiers on those projections. The difficulty modifiers may adjust the difficulty of achieving specific outcomes related to player performances within the contests. Increased difficulty modifiers (“Demons”) may elevate the challenge by setting higher performance thresholds, which, if surpassed, may result in significantly higher payouts due to the elevated difficulty involved for the player to reach this performance threshold. Decreased difficulty modifiers (“Goblins”) may lower these thresholds, making certain outcomes easier to achieve but may offer lower payouts to reflect the reduced difficulty.

One or more algorithms of the payout service 340 may integrate comprehensive data, including historical performance statistics of players, predictive analytics, and real-time performance data, to assess the adjusted probability of achieving the user-specified outcomes with the difficulty modifiers in play. This assessment may influence the calculation of payouts, ensuring that they are proportionate to the actual difficulty undertaken by the user. For example, a user applying an increased difficulty modifier (“Demon”) to a player expected to score in a particularly challenging matchup may see a potential increase in payout, acknowledging the lower probability of occurrence. This dynamic adjustment may incentivize strategic adjustments within the platform, making the fantasy sports contests more engaging and competitive.

Moreover, the payout service 340 may maintain transparency in how payouts are determined by providing users with detailed explanations of how difficulty modifiers affect their potential winnings. This approach may ensure that users are well-informed about the mechanics behind their contest entries, fostering a sense of fairness and clarity. The service's reliance on accurate and up-to-date modifier information, combined with its sophisticated analytical capabilities, may ensure that payouts are not only fair but also reflective of the unique configurations of each contest entry. Consequently, the payout service 340 may play a role in promoting a balanced and enjoyable gaming experience, encouraging users to explore various strategic avenues through the judicious application of difficulty modifiers.

The modifier service 342 may manage the operational aspects of difficulty modifiers, specifically increased difficulty modifiers (“Demons”) and decreased difficulty modifiers (“Goblins”). This modifier service 342 may determine the availability of these modifiers based on a variety of factors, including the specific context of each fantasy sports contest, player performance statistics, and prevailing market conditions. By analyzing current and historical data, the modifier service 342 may ensure that difficulty modifiers are offered to users in a manner that maintains the competitive balance and integrity of the contests. The availability of these modifiers may be dynamically adjusted to reflect real-time changes in player conditions, game circumstances, and other relevant factors that could impact the strategic assessment of applying a particular modifier.

The modifier service 342 may assess the appropriate statistics associated with each modifier. The modifier service 342 may perform a deep analysis of how applying a “Demon” or “Goblin” modifier to a player's performance projection could alter the expected outcome. For instance, a “Demon” modifier may increase the projected points a player must score in a game to achieve a higher payout, while a “Goblin” modifier may decrease the threshold, making it easier to win but with a lower payout. The modifier service 342 may calculate these adjustments based on a complex algorithm that factors in player performance trends, historical matchups data, and statistical probabilities. This may ensure that the application of modifiers is grounded in logical, data-driven analysis, providing users with meaningful choices that influence their strategy and potential winnings.

Moreover, the modifier service 342 may synthesize information to recalibrate entry fees and potential payouts in accordance with the changed difficulty level provided by the modifiers. The modifier service 342 may ensure that the financial aspects of contest participation—entry fees and potential winnings—are directly aligned with the strategic decisions made by users, including their choice of difficulty modifiers. Through its comprehensive functionality, the modifier service 342 may facilitate a more engaging, nuanced, and potentially rewarding fantasy sports experience, encouraging users to thoughtfully consider the impact of their behaviors on both their strategy and financial outcomes.

The management service 330 may include a contest parameters service 344. The contest parameters service 344 may determine and adjust various contest parameters for the fantasy sports contests. The contest parameters service 344 may utilize one or more algorithms and data analytics, focusing on integrating user-selected increased difficulty modifiers (“Demons”) and decreased difficulty modifiers (“Goblins”), to dynamically modify contest parameters such as projections, payout structures, entry fees, and performance thresholds.

Incorporating inputs from an array of one or more data points (e.g., player performance projections and difficulty modifiers), the contest parameters service 344 may employ sophisticated algorithms to recalibrate contest dynamics in real time. For example, an algorithm may adjust the projections associated with player outcomes based on the collective application of difficulty modifiers by participants. If an overwhelming number of participants apply an increased difficulty modifier to a particular player's performance projection, indicating a community-wide expectation of an exceptional performance, the contest parameters service 344 may adjust the projections to reflect the heightened anticipation, thereby ensuring balanced engagement across all outcomes.

Additionally, the contest parameters service 344 may leverage predictive analytics to anticipate changes in contest dynamics, enabling preemptive adjustments to contest parameters. The contest parameters service 344 may utilize a machine learning model that analyzes historical contest patterns and the impact of difficulty modifiers on contest outcomes, predicting future trends and automatically adjusting parameters to optimize contest balance and participant satisfaction.

The contest parameters service 344 may also take into account the financial aspect of fantasy sports contests. For example, an algorithm within the contest parameters service 344 may dynamically adjust entry fees based on the difficulty level participants are willing to accept, indicated by their choice of difficulty modifiers. A participant opting for a “Demon” may see an adjustment in the potential payout, reflecting the higher difficulty and reward associated with their lineup. The selection of a “Goblin” may lead to adjustments that offer a less lucrative payout, aligning with the decreased difficulty preference.

The contest parameters service 344 may maintain a data-driven approach to ensure the fairness and attractiveness of contests. It may process and synthesize vast amounts of data, from player projections and historical performance metrics to real-time lineup trends, to create a dynamic and engaging gaming environment. The contest parameters service 344 may adapt contest parameters in response to user behavior and external factors.

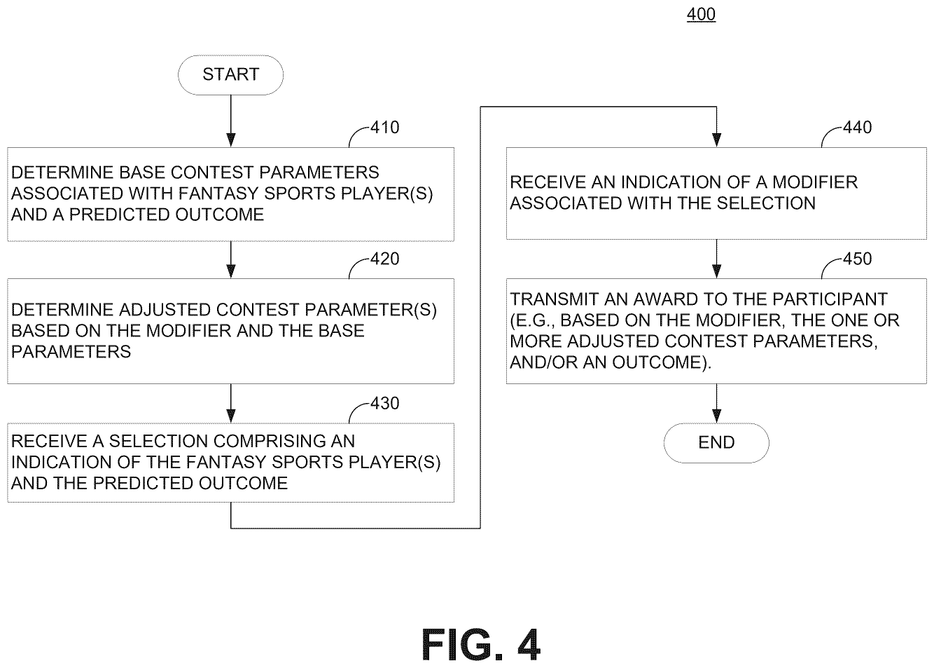

Referring now to FIG. 4, illustrated is a flowchart of a process 400, according to one example of the disclosed systems and processes. The process 400 may demonstrate a technique for dynamically adjusting the pricing and associated payouts of fantasy sports player picks by applying strategic modifiers. The process 400 may further demonstrate a technique for determining payouts by applying the strategic modifiers.

At box 410, the process 400 may include determining, for a fantasy sports contest, a plurality of base contest parameters associated with one or more fantasy sports players and a predicted outcome. The system may analyze and establish a set of base contest parameters, including an in-depth examination of the chosen players' historical performances, current season statistics, and other relevant metrics like injury reports or game conditions that might affect the predicted outcomes. For instance, if a quarterback has been on a hot streak but is facing a team with a top-tier defense in the next game, this analysis may determine the base probability of the quarterback achieving the predicted yardage. The computing devices may access vast amounts of data to ascertain these parameters (e.g., in real-time), which may include base likelihood of winning, initial payout ratios, and difficulty levels associated with the predicted outcomes.

At box 420, the process 400 may include determining, based on one or more modifiers and the plurality of base parameters, one or more adjusted contest parameters. The computing devices may recalibrate the contest dynamics to reflect the added layer of complexity introduced by the modifiers. This involves sophisticated algorithms and models that adjust the difficulty thresholds and potential rewards based on the selected modifiers. For example, applying a “demon” modifier could trigger a machine learning model that predicts a lower probability of the quarterback achieving the 300-yard mark against the tough defense but significantly increases the reward for a correct prediction. A “goblin” modifier might lower the payout but increase the chances of winning by adjusting the predicted outcomes to more achievable thresholds. This recalibration is a nuanced process, taking into account not only the specific selections and modifiers but also broader selection patterns among participants and real-time data that might affect the outcomes.

At box 420, the process 400 may include determining, based on the modifier and the plurality of base parameters, one or more adjusted contest parameters. The one more contest parameters may be recalibrated to incorporate the strategic depth introduced by one or more modifiers. This recalibration may include a sophisticated analytical process executed by computing devices comprising one or more processors. One or more algorithms and models may be employed, each selected for its ability to navigate the complexities of fantasy sports dynamics, to adjust the contest parameters in line with the one or more modifiers.

A scaling factor may be applied to the base contest parameters, e.g., to fine-tune the contest dynamics to reflect the added difficulty or safety introduced by modifiers such as “demons” or “goblins”. For example, a “demon” modifier may be reflected in the adjusted contest parameters through a scaling factor applied to the base contest parameters that amplifies the potential reward should the quarterback indeed surpass 300 throwing yards against a formidable defense. Moreover, a scaling factor may be applied to the base contest parameters to decrease the likelihood the participant will achieve the outcome. Opting for a “goblin” modifier, which signifies a cautious approach, may apply a scaling factor that reduces the reward but increases the likelihood of achieving the predicted outcome, e.g., by setting a more attainable performance threshold for the player.

According to some aspects, a machine learning model may be used to predict outcomes associated with players, e.g., allowing for a dynamic adjustment of contest parameters that are finely tuned to the nuances of player performance and game conditions. For example, a machine learning model may analyze a wide receiver's past performances against similar defensive setups to estimate a probability of the quarterback achieving a certain yardage in an upcoming game. This predictive capability, combined with the strategic intent signaled by the modifier, may ensure that the adjusted contest parameters are both realistic and aligned with the participant's difficulty preferences.

Moreover, Bayesian models may be used by analyzing selection patterns across a plurality of participants. The selection patterns may include trends and common strategies, enabling the system to recalibrate projections and payouts in a manner that maintains competitive balance while honoring the collective wisdom of the participant base. For example, if a significant number of participants lean towards “demon” modifiers for underdog players in a given week, the Bayesian analysis may adjust the contest parameters to reflect these adjustments, ensuring that the contest remains challenging yet fair.

The determination of adjusted contest parameters may be further enriched by real-time data integration. Events unfolding in the real world (e.g., last-minute player injuries, unexpected weather conditions, or coaching changes) may significantly impact player performance and, by extension, fantasy contest outcomes. By incorporating this real-time data, the system may ensure that the adjusted contest parameters remain relevant up to the moment the game kicks off.

Moreover, the adjusted contest parameters may be presented to participants through a user interface. The user interface may display the recalibrated projections and potential rewards, as well as provide insights into how the participant's choices and broader selection trends may have influenced the adjustments. This transparency may foster a deeper engagement with the contest, allowing participants to appreciate the strategic depth of their selections and modifiers in the context of the dynamic fantasy sports ecosystem.

At box 430, the process 400 may include receiving, from a participant of the fantasy sports contest, a selection comprising an indication of the one or more fantasy sports players and a predicted outcome associated with the one or more fantasy sports players. One or more computing devices, including one or more processors, may receive and/or record the participant's selections, e.g., including the names of the chosen players and the predicted outcomes for each. For example, a participant, perhaps an avid fantasy sports enthusiast, may engage with a fantasy sports platform to craft a team that reflects both their knowledge of the sport and their strategic foresight. For instance, in the throes of the National Football League (NFL) season, the participant may select a quarterback renowned not just for his arm strength but for his ability to perform under pressure, alongside a running back whose consistency has been the talk of the league. As the participant navigates the user interface, be it on a mobile application or a web platform, the participant may be presented with detailed statistics, player histories, and predictive analytics to aid in the decision-making process. Imagining a weekend clash that pits an underdog team against a top-tier defense, the participant may predict the quarterback will break the 300-yard passing mark and the running back will find the end zone twice.

At box 440, the process 400 may include receiving, from the participant, an indication of a modifier associated with the selection, e.g., as participants fine-tune their selections with strategic modifiers. Participants may apply a “demon” modifier to increase the payout for their prediction, based on the high volatility of the quarterback's performance against tough defenses or opt for a “goblin” modifier to play it safe with the consistent running back. This selection may be facilitated through the user interface, where the implications of each modifier on the potential payout and difficulty threshold are clearly displayed. The system may capture the participant's choice, feeding this new variable into the contest dynamics. The choice of modifier may be a testament to the participant's confidence in their prediction.

At box 450, the process 400 may include transmitting, based on the modifier, the one or more adjusted contest parameters, and an outcome associated with the selection, an award to the participant. Actual game outcomes may be matched against the participants' predictions and adjusted contest parameters to determine awards. For instance, if the quarterback indeed manages to throw for over 300 yards despite the odds, the participant who chose to increase their potential payout with a “demon” modifier may be rewarded handsomely. The system, through its advanced computational capabilities, may automatically calculate the awards, taking into account the recalibrated projections and the actual performance of the selected players. According to some aspects, a detailed breakdown may be provided to the user of how the outcomes were derived, reinforcing transparency and trust in the system. The process 400, from selection to award distribution, exemplifies the dynamic and interactive nature of modern fantasy sports contests, enhanced by sophisticated computing technologies and algorithmic precision.

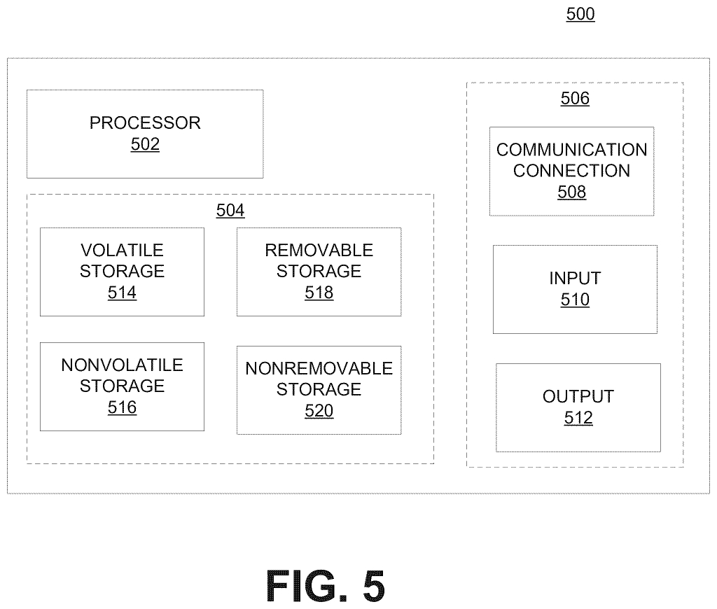

FIG. 5 is a block diagram of a computing device 500 that may be connected to or include a component of environment 200. Computing device 500 may include hardware or a combination of hardware and software. The functionality to facilitate fantasy sports contests may reside in one or a combination of computing devices 500. Computing device 500 depicted in FIG. 5 may represent or perform functionality of an appropriate computing device 500, or a combination of computing devices 500, such as, for example, a component or various components of a fantasy sports contest system, a computing device, a processor, a server, a gateway, a database, a firewall, a router, a switch, a modem, an encryption tool, a virtual private network (VPN), a network access control (NAC) device, a secure web gateway, or the like, or any appropriate combination thereof. It is emphasized that the block diagram depicted in FIG. 5 is exemplary and not intended to imply a limitation to a specific example or configuration. Thus, computing device 500 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Computing device 500 may include a processor 502 and a memory 504 coupled to processor 502. Memory 504 may contain executable instructions that, when executed by processor 502, cause processor 502 to effectuate operations associated with a fantasy sports contest. As evident from the description herein, computing device 500 is not to be construed as software per se.

In addition to processor 502 and memory 504, computing device 500 may include an input/output system 506. Processor 502, memory 504, and input/output system 506 may be coupled together (coupling not shown in FIG. 5) to allow communications between them. Each portion of computing device 500 may include circuitry for performing functions associated with each respective portion. Thus, each portion may include hardware, or a combination of hardware and software. Accordingly, each portion of computing device 500 is not to be construed as software per se. Input/output system 506 may be capable of receiving or providing information from or to a communications device or other network entities configured for fantasy sports contests. For example, input/output system 506 may include a wireless communication (e.g., 3G/4G/5G/GPS) card. Input/output system 506 may be capable of receiving or sending video information, audio information, control information, image information, data, or any combination thereof. Input/output system 506 may be capable of transferring information with computing device 500. In various configurations, input/output system 506 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 506 may include a Wi-Fi finder, a two-way GPS chipset or equivalent, or the like, or a combination thereof.

Input/output system 506 of computing device 500 also may contain a communication connection 508 that allows computing device 500 to communicate with other devices, network entities, or the like. Communication connection 508 may include communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 506 also may include an input device 510 such as keyboard, mouse, pen, voice input device, or touch input device. Input/output system 506 may also include an output device 512, such as a display, speakers, or a printer.

Processor 502 may be capable of performing functions associated with fantasy sports contests, such as functions for personalizing and dynamically adjusting game parameters, as described herein. For example, processor 502 may be capable of, in conjunction with any other portion of computing device 500, dynamically adjusting fantasy sports contest parameters based on user-selected modifiers, as described herein.

Memory 504 of computing device 500 may include a storage medium having a concrete, tangible, physical structure. As is known, a signal does not have a concrete, tangible, physical structure. Memory 504, as well as any computer-readable storage medium described herein, is not to be construed as a signal. Memory 504, as well as any computer-readable storage medium described herein, is not to be construed as a transient signal. Memory 504, as well as any computer-readable storage medium described herein, is not to be construed as a propagating signal. Memory 504, as well as any computer-readable storage medium described herein, is to be construed as an article of manufacture.

Memory 504 may store any information utilized in conjunction with fantasy sports contests. Depending upon the exact configuration or type of processor, memory 504 may include a volatile storage 514 (such as some types of RAM), a nonvolatile storage 516 (such as ROM, flash memory), or a combination thereof. Memory 504 may include additional storage (e.g., a removable storage 518 or a non-removable storage 520) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by computing device 500. Memory 504 may include executable instructions that, when executed by processor 502, cause processor 502 to effectuate operations associated with fantasy sports contests.

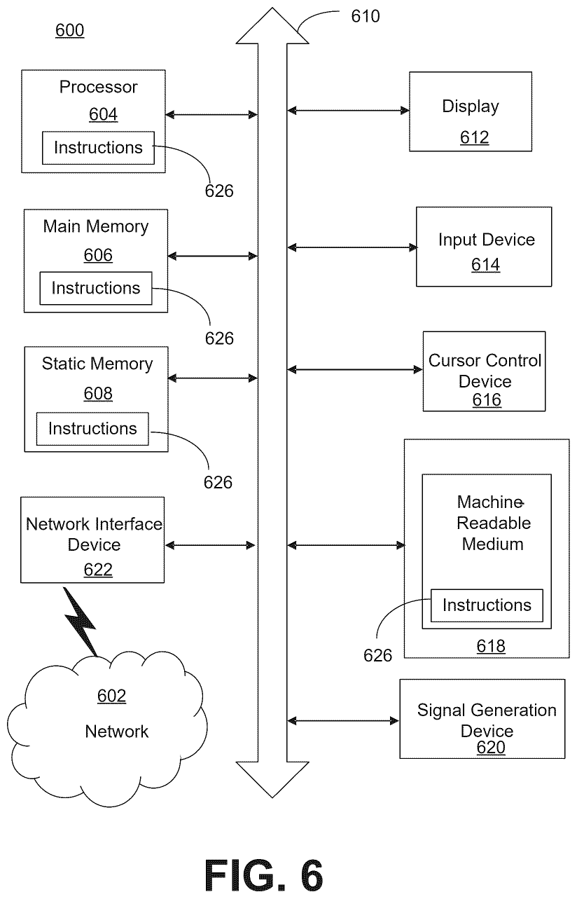

FIG. 6 depicts an exemplary diagrammatic representation of a machine in the form of a computer system 600 within which a set of instructions, when executed, may cause the machine to perform any one or more of the methods described above. One or more instances of the machine can operate, for example, as processor 502, server 204, database 206, client device 350, and other devices of FIGS. 1-5. In some examples, the machine may be connected (e.g., using a network 602) to other machines. In a networked deployment, the machine may operate in the capacity of a server or a client user machine in a server-client user network environment, or as a peer machine in a peer-to-peer (or distributed) network environment.

The machine may include a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 600 may include a processor (or controller) 604 (e.g., a central processing unit (CPU)), a graphics processing unit (GPU, or both), a main memory 606 and a static memory 608, which communicate with each other via a bus 610. The computer system 600 may further include a display unit 612 (e.g., a liquid crystal display (LCD), a flat panel, or a solid-state display). Computer system 600 may include an input device 614 (e.g., a keyboard), a cursor control device 616 (e.g., a mouse), a disk drive unit 618, a signal generation device 620 (e.g., a speaker or remote control) and a network interface device 622. In distributed environments, the examples described in the subject disclosure can be adapted to utilize multiple display units 612 controlled by two or more computer systems 600. In this configuration, presentations described by the subject disclosure may in part be shown in a first of display units 612, while the remaining portion is presented in a second of display units 612.

The disk drive unit 618 may include a tangible computer-readable storage medium on which is stored one or more sets of instructions (e.g., instructions 626) embodying any one or more of the methods or functions described herein, including those methods illustrated above. Instructions 626 may also reside, completely or at least partially, within main memory 606, static memory 608, or within processor 604 during execution thereof by the computer system 600. Main memory 606 and processor 604 also may constitute tangible computer-readable storage media.

While examples of a system for fantasy sports contests have been described in connection with various computing devices/processors, the underlying concepts may be applied to any computing device, processor, or system capable of facilitating a fantasy sports contest. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer readable storage medium is not a propagating signal. A computer-readable storage medium as described herein is an article of manufacture. When the program code is loaded into and executed by a machine, such as a computer, the machine becomes a device for fantasy sports contests. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with fantasy sports contests as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an erasable programmable read-only memory (EPROM), a gate array, a programmable logic device (PLD), a client computer, or the like, the machine becomes a device for implementing fantasy sports contests as described herein. When implemented on a general-purpose processor, the program code combines with the processor to provide a unique device that operates to invoke the functionality of a fantasy sports contest.

While the disclosed systems have been described in connection with the various examples of the various figures, it is to be understood that other similar implementations may be used, or modifications and additions may be made to the described examples of a fantasy sports contest system without deviating therefrom. For example, one skilled in the art will recognize that a fantasy sports contest system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—dynamically adjusting fantasy sports contest parameters based on user-selected modifiers—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

1. One or more computing devices, comprising one or more processors, configured to:
determine, for a fantasy sports contest, base contest parameters associated with a plurality of fantasy sports players and a predicted outcome associated with the one or more fantasy sports players, wherein the plurality of base contest parameters and the predicted outcome are determined based on real-time performance metrics associated with the plurality of fantasy sports players and the predicted outcome comprises a performance threshold;
calculate, by a machine learning model, an expected distribution of the base contest parameters across a plurality of outcomes associated with the predicted outcome;
determine a first modified performance threshold and a second modified performance threshold of the plurality of outcomes based on the expected distribution of the base contest parameters, wherein the first modified performance threshold is higher than the performance threshold and the second modified performance threshold is lower than the performance threshold;
predict one or more adjusted contest parameters associated with each of the first modified performance threshold and the second modified performance threshold;
display, on a client device, at least one first modifier comprising the first modified performance threshold and the one or more adjusted contest parameters and at least one second modifier comprising the second modified performance threshold and the one or more adjusted contest parameters;
receive a selection comprising an indication of the one or more fantasy sports players and the predicted outcome from the client device;
receive, from the participant, an indication of the at least one first modifier or the at least one second modifier from the client device; and
transmit an award to the participant based on the at least one first modifier or the at least one second modifier, the one or more adjusted contest parameters, and an outcome associated with the selection.

2. The one or more computing devices of claim 1, further configured to: apply a scaling factor to the base contest parameters.

3-5. (canceled)

6. The one or more computing devices of claim 1, further configured to determine, based on a Bayesian model, one or more selection patterns of a plurality of participants, wherein the one or more adjusted contest parameters are determined based on the one or more selection patterns.

7. The one or more computing devices of claim 1, wherein the one or more adjusted contest parameters include a likelihood of winning and potential payout amounts.

8. (canceled)

9. The one or more computing devices of claim 1, wherein displaying the at least one first modifier and the at least one second modifier further comprises displaying a first award associated with the at least one first modifier and a second award associated with the at least one second modifier.

10. The one or more computing devices of claim 1, further configured to determine a performance variability associated with the participant, wherein the one or more adjusted contest parameters are determined based on the performance variability.

11. The one or more computing devices of claim 1, wherein the adjusted contest parameters are further based on a historical accuracy of one or more previously adjusted contest parameters.

12. The one or more computing devices of claim 1, wherein the adjusted contest parameters are further based on one or more live game events associated with the one or more fantasy sports players.

13. The one or more computing devices of claim 1, further configured to determine, through collective filtering, one or more correlations associated with a plurality of selections, wherein the one or more adjusted contest parameters are further based on the one or more correlations.

14. The one or more computing devices of claim 1, further configured to determine, using an elasticity-based algorithm, the award based on a plurality of selections made in response to changes in contest parameters.

15. The one or more computing devices of claim 1, further configured to present, by a user interface on the client device, an adjusted contest parameter of the one or more adjusted contest parameters.

16. The one or more computing devices of claim 1, further configured to determine, through an aggregation model, a collective wisdom of a plurality of participants, wherein the one or more adjusted contest parameters are further based on the collective wisdom of the plurality of the participants.

17. A method performed by one or more computing devices, the method comprising:
determining, for a fantasy sports contest, a plurality of base contest parameters associated with a plurality of fantasy sports players and a predicted outcome associated with the one or more fantasy sports players, wherein the plurality of base contest parameters and the predicted outcome are determined based on real-time performance metrics associated with the plurality of fantasy sports players and the predicted outcome comprises a performance threshold;
calculating, by a machine learning model, an expected distribution of the base contest parameters across a plurality of outcomes associated with the predicted outcome;
determining a first modified performance threshold and a second modified performance threshold of the plurality of outcomes based on the expected distribution of the base contest parameters, wherein the first modified performance threshold is higher than the performance threshold and the second modified performance threshold is lower than the performance threshold;
predicting one or more adjusted contest parameters associated with each of the first modified performance threshold and the second modified performance threshold;
displaying, on a client device, at least one first modifier comprising the first modified performance threshold and the one or more adjusted contest parameters and at least one second modifier comprising the second modified performance threshold and the one or more adjusted contest parameters;
receiving, from a participant of a fantasy sports contest, a selection comprising an indication of the one or more fantasy sports players and the predicted outcome;
receiving, from the participant, an indication of the at least one first modifier or the at least one second modifier from the client device; and
transmitting an award to the participant based on the at least one first modifier or the at least one second modifier, the one or more adjusted contest parameters and an outcome associated with the selection.

18. The method of claim 17, further comprising: applying a scaling factor to the base contest parameters.

19. (canceled)

20. A system comprising: one or more processors; and
a memory coupled with the one or more processors, the memory storing executable instructions that when executed by the one or more processors cause the one or more processors to effectuate operations comprising:
determining, for a fantasy sports contest, a plurality of base contest parameters associated with a plurality of fantasy sports players and a predicted outcome associated with the one or more fantasy sports players, wherein the plurality of base contest parameters and the predicted outcome are determined based on real-time performance metrics associated with the plurality of fantasy sports players and the predicted outcome comprises a performance threshold;
calculating, by a machine learning model, an expected distribution of the base contest parameters across a plurality of outcomes associated with the predicted outcome;
determining a first modified performance threshold and a second modified performance threshold of the plurality of outcomes based on the expected distribution of the base contest parameters, wherein the first modified performance threshold is higher than the performance threshold and the second modified performance threshold is lower than the performance threshold;
predicting one or more adjusted contest parameters associated with each of the first modified performance threshold and the second modified performance threshold;
displaying, on a client device, at least one first modifier comprising the first modified performance threshold and the one or more adjusted contest parameters and at least one second modifier comprising the second modified performance threshold and the one or more adjusted contest parameters;
receiving, from a participant of a fantasy sports contest, a selection comprising an indication of the one or more fantasy sports players and the predicted outcome;
receiving, from the participant, an indication of the at least one first modifier or the at least one second modifier from the client device; and
transmitting an award to the participant based on the at least one first modifier or the at least one second modifier, the one or more adjusted contest parameters and an outcome associated with the selection.
